(19) United States
(12) Patent Application Publication
(10) Pub. No.: US 2022/0051581 A1
(43) Pub. Date: Feb. 17, 2022

(54) PERSONALIZED USER EDUCATION SYSTEM

(71) Applicant: Wells Fargo Bank, N.A., San Francisco, CA (US)

(72) Inventors: John C. Brenner, Chesterfield, MO (US); Donna Marie Greene, Oakboro, NC (US); Carter C. Hansen, Huntersville, NC (US); Tambra Nichols, Charlotte, NC (US); Elizabeth Long Swindler, Gastonia, NC (US); Keith Meade Sykes, Charlotte, NC (US)

(21) Appl. No.: 16/102,246

(22) Filed: Aug. 13, 2018

(51) Int. Cl. G09B 5/12; G09B 5/14; G09B 19/00; G06Q 30/06

(52) U.S. Cl. CPC G09B 5/12; G06Q 30/0621; G09B 19/00; G09B 5/14

(57) ABSTRACT

A computer-implemented system and method are provided for preparing and transmitting an education content module to a user. The method comprises receiving educational information and processing the educational information to produce an education content module that is tagged based on its content with a content engine. The tagged module is stored in an educational content module database in a memory of the system. The following preferences are determined and stored: a user packaging preference for packaging of the education content module, a user delivery preference for delivering the education content module, and an educational interest preference for locating educational information. Responsive to a trigger criterion associated with the user being met, contents of the education content module are formatted into a formatted education content module according to the user packaging preference, and sent to the user via the network interface according to the user delivery preference.

### TECHNICAL FIELD

Described herein is a computer-based technical system that provides customized user education based on user preferences for packaging and delivery and educational interest preferences.

### BACKGROUND

A user of a product or service may desire to educate themselves on the product or service but may have constraints in terms of available time, background knowledge, or devices and technology used to access educational information. Although the user can seek out on-line educational materials on their own, it would be beneficial to have better management from a user education system that can provide technical aspects of content delivery in a personalized manner.

### SUMMARY

Disclosed herein is a computer-implemented technical method for preparing and transmitting an education content module to a user. The method comprises, using a processor for receiving educational information via a network interface and processing the educational information to produce an education content module that is tagged based on its content with a content engine. The tagged module is stored in an educational content module database in a memory of the system. The following preferences are determined and stored in the memory: a user packaging preference for packaging of the education content module, a user delivery preference for delivering the education content module, and an educational interest preference for locating educational information of interest to the user. Responsive to a trigger criterion associated with the user being met, contents of the education content module are formatted into a formatted education content module according to the user packaging preference, and sent to the user via the network interface according to the user delivery preference.

Disclosed herein is also a personalized user education system comprising a hardware processor, a network interface, a non-volatile memory-based storage device connected to the hardware processor comprising instructions that, when executed on the processor, configure the processor to perform various operations. In the system, educational information is received via the network interface, and the educational information is processed to produce an education content module that is tagged based on its content with a content engine and stored in an education content module database in the storage device. The system determines and stores in the storage device: a user packaging preference for packaging of the education content module, a user delivery preference for delivering the education content module, and an educational interest preference for locating educational information of interest to the user. Responsive to a trigger criterion associated with the user being met, the

contents of the education content module are formatted into a formatted education content module according to the user packaging preference, which is sent to the user via the network interface according to the user delivery preference.

Described herein is also a non-transitory computer-readable storage medium, the computer-readable storage medium including instructions that when executed by a processor, cause the processor to perform the operations described above.

### BRIEF DESCRIPTION OF THE DRAWINGS

In the drawings, which are not necessarily drawn to scale, like numerals may describe similar components in different views. Like numerals having different letter or numeric suffixes may represent different instances of similar components.

The drawings illustrate generally, by way of example, but not by way of limitation, various embodiments discussed in the present document.

FIG. 1 is a block diagram providing an overview of an example personalized user education system, according to an implementation.

FIG. 2 is a flowchart illustrating an example process of the system interacting with a user to provide educational materials to the user, according to an implementation.

FIG. 3 is a block diagram illustrating an example of a machine that may be a computer on which various processes described herein may be performed.

FIG. 4 is a block diagram of an example of a distributed computing system within which various processes described herein may be performed.

### DETAILED DESCRIPTION

Described below is a technical system that provides a comprehensive technically customized educational experience for a user that is based on a user's preference for packaging and delivery of various educational material. Educational information is obtained from external sources, advisors, or internal educational material producers. The educational information is bundled into tagged education content modules which are tagged with various meta-data to allow the information to be searched and utilized according to a variety of criteria, including content.

A trigger, which may be a user request, periodic timer expiration, or importation of new educational material relevant to the user, may begin a process of providing education content modules to the user. The user may specify various formats for receiving the information contained in the modules, as well as a mechanism for delivery. In this way, a user may conveniently be presented with educational information in a way that is best suited for them and on topics that are of interest to them. The system may infer topics that may be of interest to the user as well as the formatting and delivery of the educational materials.

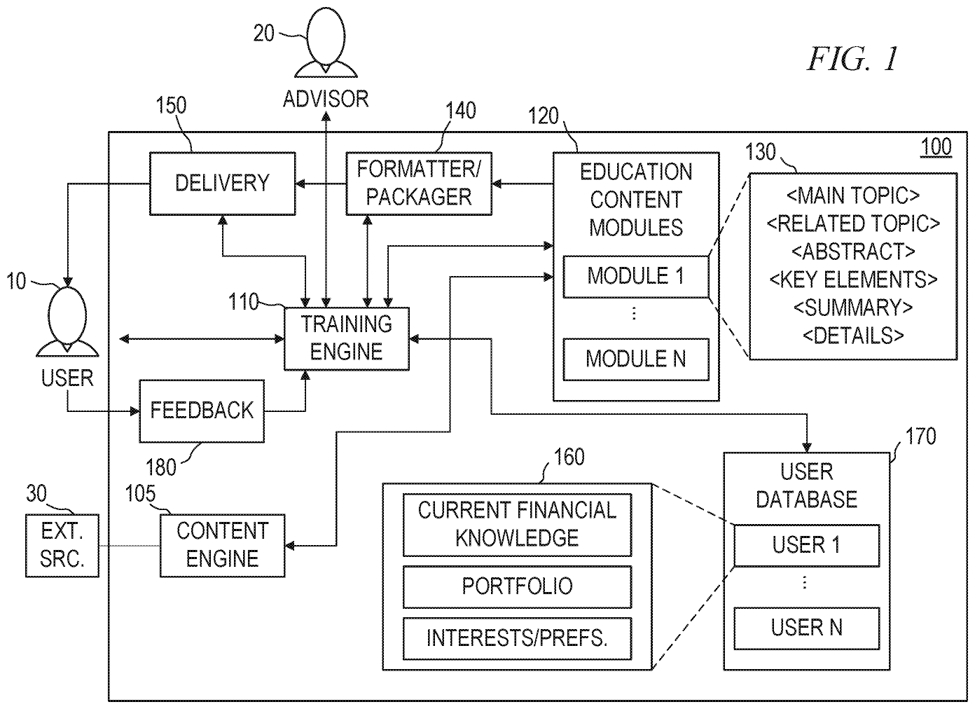

FIG. 1 is a block diagram illustrating a personalized user education system 100 that may be utilized to present educational materials to a user 10 based on user preferences for the packaging and delivery of content that is of interest to them. The example presented for illustrative purposes herein is a training system for a financial institution that may utilize an advisor 20 to assist the user, however the system 100 is not so limited. The system may be a system 400 as described in more detail below, and may include one or more machines 300 as described below.

The educational information may originate from external content sources 30, or it may originate from advisors 20 or other internal entities. The educational information may be received by way of a network interface, either from the external content sources, advisor devices, such as a machine 300, or a machine 300 of other internal entities. By way of example, a news service as the external content source 30 might produce a news item such as an article on falling bond yields. This article may be publicly accessible and located on the new service's web page in text form. A content engine 105 may access this news article as educational information via a file transfer, web page scrape, bot, or by any other mechanism. The content engine 105 may parse the article and consider keywords and content analysis that may possibly utilize AI. This parsing may result in education content modules 130 that may be stored in an education content module data store 120. The parsing of the content engine 105 may add tags, when possible to the education content modules 130. These tags may include a main topic, related topic(s), abstract, key elements, summary, and details section. When the education content modules 130 are produced by an advisor 20 or internally, a utility may be provided that allows express the content creator to provide tagging of the modules 130 to minimize errors. External sources for, e.g., financial information may include web sites such as Investopedia, MarketWatch, news sources, publicly accessible databases, and the like.

One component of the system 100 is the training engine 110. The user 10 may initially provide various preferences to the system via the training engine 110. These preferences may include a user packaging preference for an educational content module 130. Such a packaging preference may include details about a volume of information to be delivered at one time. For example, if the user 10 primarily receives educational content only during a fifteen-minute commute, then the user 10 may specify that the information should be broken down into fifteen-minute pieces. Another user 10 primarily receives educational content after dinner, and thus may specify that the information should be broken down into one-hour pieces. The same user 10 may specify both, and that varies by time of day (morning versus evening) as well as a type of device the user is on. For example, the user 10 may primarily access her cell phone while commuting to work in the morning, and thus may want fifteen-minute digestible pieces, whereas she may access her laptop later in the evening and thus may want one-hour digestible pieces. This preference information may be stored in a user record 160 of a user database 170, discussed in more detail below.

Although the user packaging preference may be specified by the user 10, it may also be specified by the advisor 20, or it may be inferred, initially by default settings or based on demographic or other information known about the user 10. The user packaging preference may be inferred based on at least one of a time of day, a currently in-use user device, a location, and historical records of viewing habits of the user. The user packaging preference may furthermore evolve over time, as the user's 10 use habits of the modules 130 become known by the system 100. For example, if the user, in the morning, requests shorter modules (or pauses longer modules) on the commute into work, then the system may package the modules 130 for the fifteen-minute commute, whereas if the user, in the evening, requests longer modules, then the system may package the modules 130 for a one-hour sitting.

A formatter/packager 140 may handle the actual formatting and packaging of the education content modules 130 for the user, based on the user packaging preference. For example, the formatter/packager 140 may access a two-and-a-half-hour module 130 and break it down into two fifteen-minute modules for consecutive mornings when the user 10 is commuting, and two one-hour modules for consecutive evenings when the user 10 is at her computer. The formatter/packager 140 may simply just break up or concatenate content for presentation to the user 10, or it may add header or footer information to the pieces, or in some other way modify it so that it appears more complete to the user 10.

The formatter/packager 140 may also do various conversions of the modules 130 to a different format. For example, if the user 10 drives to work every day, then during the time she's driving, she will want the presentation to be hands-free and not require visual attention. In that case, the formatter/packager 140 may change the educational module pieces to an audio format. For an audio-visual educational content module 130, this may simply involve removing the video and retaining the audio. For a text-based educational content module 130, a text-to-voice routine may be utilized. If the information is in a different language, a translator may be provided as well. There are many different types of conversions/translations possible.

Additionally, the user 10 may specify, and the formatter/packager 140 may implement, a depth of coverage, level of sophistication, or level of detail to be presented, and this may vary based on the subject matter time of day, location, etc. In a case where the user does not want a great depth of coverage, only the abstract of the module 130 may be presented to the user 10, or key words and paragraphs may be extracted, organized, and presented. Additional tags may be utilized for materials corresponding to different levels of detail. Thus, one module 130 may be formatted and presented to the user in a variety of ways.

The training engine 110 may additionally assess a level and sophistication of the user based on the education content that the user consumes, testing, or survey responses. A level of sophistication may be inferred as well, based on user 10 demographics. By way of example, someone just graduating college might want to know what a money market is, and thus their educational interest preferences might include basic money market educational information. After they have completed one or more education content modules 130 on topic, their educational interest preferences may be updated to include more complicated types of securities, or topics such as the importance of diversifying their account. More advanced topics might involve technical trading concepts, ways other users are using technical performance and chart data to identify investment opportunities that are more speculative. Another would be advanced options trading and different types of options trade, types of calls and puts, using options to generate income from your investments or using options to hedge themselves against losses in their position.

These preferences may also include a user delivery preference for an educational content module 130. Such a delivery preference may include details about how the user 10 would prefer to receive the information for example, whether the user receives text based information via email, text message, a chat, web link, or an in-application dedicated application display screen. The user 10 may further specify a data bandwidth or overall amount limitation, such as when they are on a mobile phone and may have to pay extra for exceeding a data limit. This delivery preference information may be stored in a user record 160 of a user database 170, discussed in more detail below. The delivery processor 150 may access the user delivery preference and receive the education content module 130 information that has been processed by the formatter/packager 140 and deliver it to a user device in the format or channel specified by the user. The user device may be a machine 300, as described in more detail below.

As with the user packaging preference, here the user delivery preference may be specified by the user 10, it may also be specified by the advisor 20, or it may be inferred, initially by default settings or based on demographic or other information known about the user 10. The user delivery preference may be inferred based on at least one of a time of day, a currently in-use user device, a location, and historical records of viewing habits of the user. The user delivery preference may furthermore evolve over time, as the user's 10 use habits of the modules 130 become known by the system 100. For example, if the user, in the morning, is on their mobile device on the commute into work, then the system may decide to limit the bandwidth of an HD video presentation to a video presentation in much lower resolution and provide this to the user at that time. The formatter/packager 140 may further handle the actual formatting and packaging of the education content modules 130 for the user, based on the user delivery preference.

These preferences may also include an educational interest preference for an educational content module 130. Such a delivery preference may include details about topics the user 10 might be interested in. For example, the user 10 may have a particular interest in municipal bonds or a particular mutual fund. The training engine 110 may utilize the tags of the modules 130 in order to locate modules that are directed to (or related to) the educational interests of the user. For example, if the user 10 identified the ABC Mutual Fund as being an educational interest, the training engine 110 may locate one or more existing education content modules 130 in the education content module data store 120 about the ABC Mutual Fund to provide for the user 10. The training engine 110 may also consider related content, such as general discussions about mutual funds, or common problems facing mutual funds in general.

Again, as with the user packaging preference, here the educational interest preference may be specified by the user 10, it may also be specified by the advisor 20, or it may be an inferred education interest, initially by default settings or based on demographic or other information known about the user 10, and it may also take into account information in the user's record 160—by way of example only, the user's 10 investment portfolio content. If the user's 10 investment portfolio is mostly comprised of mutual funds, then the educational interest preference may include various topics related to mutual funds. Goals of the user may also be included for example, home ownership. If the user 10 has indicated an interest in owning a home one day, then, for example, educational interest preferences may also be updated to include an interest in mortgages and homeowner's insurance. The system 100 may have other criteria for determining what the user 10 should be learning about, given their current portfolio, goals, and objectives. The educational interest preference may furthermore evolve over time, as the user's 10 use habits of the modules 130 become known by the system 100, the user's 10 portfolio changes, the user 10 completes certain modules 130, or new potential areas of interest become available.

The education content modules 130 may be organized and grouped together as a course, or contain information related to a prerequisite structure so that one module 130 is recommended prior to receiving another modules 130. Or the organization could simply indicate related modules 130 or those that may be of interest to the user 10 (e.g., “if you liked this module 130, then you may like these others as well”). The grouping may be in a form of links or other information stored in the module 130 or accessed by the training engine 110 in some other location. In addition to the modules 130 themselves containing grouping or linking information, the grouping may be performed by the training engine based on various tags having identical or related values. The training engine 110 in conjunction with information stored in the user record 160 may provide a progress chart through modules 130 on particular topics such that the completion of a certain group of modules 130 may constitute “certification” in a particular subject. These charts may be provided to the user 10 on the user device so that the user may track progress. In one implementation, it may be possible to provide the user 10 with a test on the subject matter of the module 130 in order to measure proficiency and highlight area that the user 10 may wish to review again.

In one implementation, a feedback processor 180 may receive feedback from the user 10 about the educational information presented to the user 10. The feedback processor 180 may perform analytics of the educational content sent and when the feedback from the user 10 is positive, provide the training engine with the positive feedback so that the user 10 may receive more educational content that is similar to that for which the positive feedback is provided. Conversely, when the feedback from the user 10 is negative, the feedback processor 180 may provide the training engine with the negative feedback so that the user 10 may receive less educational content that is similar to that for which the negative feedback is provided. If one module 130 is being consumed by the users disproportionately from others, the feedback processor 180 may analyze its attributes so that information having similar attributes may be acquired as well. The attributes may be directed to content (e.g., bitcoin), delivery format (e.g., two-minute video), or any other characteristic.

The feedback processor 180 may also be utilized to share feedback information with advisors 20 or other users 10 so that modules 130 having a more positive rating are more likely to show up in other users' 10 feeds and modules 130 having a more negative rating are less likely to show up in other users' 10 feeds.

In one implementation, the initiation of sending an education content module 130 to the user 10 may be performed when a trigger criterion is met, and the trigger criterion may be in the form of a push or a pull criterion. The trigger criterion as a pull criterion is straightforward in that the user 10 pulls the education content to view on their device. This may be performed by the user 10 requesting a. user-requested search on particular topics or other keywords. In this scenario, the user 10 may interact with the training engine 110 and provide keywords to a search field displayed on the user device. The training engine 110 may then search the education content module database 120 for education modules 130 containing matching or related tags.

In another implementation, the trigger criterion is a push criterion, in that the information in the education modules 130 is pushed to the user 10 without a direct request from the user. In one implementation, the trigger criterion may be completion of processing new material by the content engine 105 that is tagged with keywords indicated by the user as being in their educational interest preferences may be sent to the user 10 upon a successful storage in a new education content module 130. In another implementation, an expiration of a periodic timer may trigger a search for information relevant to the user's educational interest preferences in the education content modules database 120. Additionally, the advisor 20 or other entity may see new material in the module database 120 that he knows his user 10 may be interested in and push the module 130 to the user 10 by issuing an instruction (e.g., via a user interface such as a button press, drop down menu and the like) to the system 100) to the training engine 110.

The push implementation may send the actual content of the module 130 via the formatter/packager 140 and the delivery processor 150, or it may simply send the user 130 a link or action element that the user 10 may select to initiate the transmission of the content of the module 130 or ignore. In this implementation, the user's 10 selection or ignoring of the link may be used by the training engine 110 to further modify the educational interest preferences. The push and pull criteria as trigger criteria may both be present and operative in the system 100 at the same time.

In one implementation, an interface to the user 10 may be provided by the system 100 in a form of a digital notebook that the user 10 may access. The digital notebook may appear as a virtual notebook on a display of the user's 10 device. The digital notebook may contain a folder-file layout, and this may serve, in one implementation, as the user interface for providing the user's 10 educational materials. Access may be via a browser web page, an app on the user's device, or part of a client program running on the user's 10 device that interacts with a server of the system 100. The digital notebook may operate in a similar manner to a dashboard, and additional information, in one implementation, may appear as a post-it note that pops up for the user, and contains interactive information.

The digital notebook may have a secure portion and a non-secure portion. The secure portion of the user's 10 digital notebook may allow access to the user of their sensitive information, such as their portfolio holdings/value, account information, and the like. However, the educational portion of the user's 10 digital notebook need not be secure and thus need not require the user 10 to provide authentication credentials in order to access it. The training engine 110 may thus access secure user 10 information in order to determine proper education content modules 130 to send to the user, but then controls the transfer of this information to the user in the non-secure display portion of the user's notebook. Once a user 10 has viewed the information from an education content module 130, it may be removed from their digital notebook, but may still be made accessible by searching, by an index, link, table of contents, or other referencing mechanism.

By way of example, a user 10 may desire, as an overall goal, to build a portfolio, but may have questions around selecting specific investments, placing trades, tax questions, and so on. If the user is navigating through their interface and does not understand what a particular report is for, or what some of the data elements on the report are, the training engine could map educational content about the report from the education content modules 130 and put the educational information into their notebook. The training engine 110 may provide some form of a flag for the user, or provide an interface where the user 10 may indicate that they want to learn about a particular topic. The advisor 20 may also oversee use of the system 100 by the user 10 and help guide them by suggesting various modules 130 that may be in line with the user's goals. In one implementation, this may simply be a notification or a link sent to the user 10 for a module 130. In another implementation, the advisor 20 may be able to adjust the educational interest preferences of the user to include various topics.

Advantageously, the system 100 described herein may provide educational information to the user 10 at a pace and level that the user 10 is comfortable with and may create a specific educational path for the user.

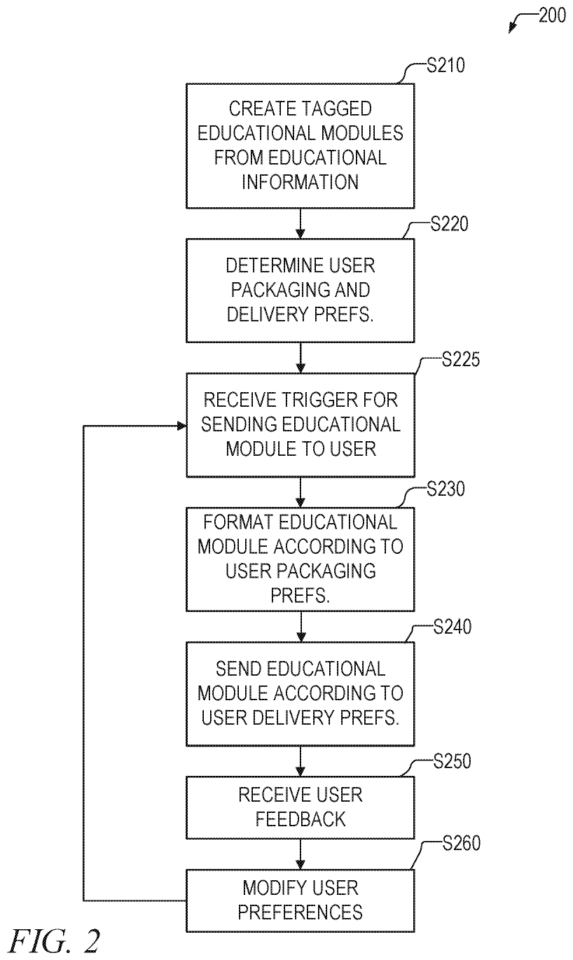

FIG. 2 is a flowchart illustrating an example process 200 of the system 100 interacting with a user 10. In operation S210, the content engine 105 receives educational information from either an external source 30, an advisor 20, or other internal source and creates educational modules 130 that are tagged with additional information that may be used to retrieve the educational module 130. In operation S220, the training engine 110 acquires preference information from the user 10 that may include user packaging preferences and user delivery preferences and stores them in a user record 160 of a user database 170.

In operation S225, the system 100 receives some type of trigger that initiates the sending of an education content module 130 to the user. The trigger may be a periodic timer, the ingestion of some new information by the content engine 105, completion of another education content module 130, or any other form of activity. Upon execution of the trigger, in operation S230, an education content module 130 is located and formatted according to the user packaging preferences. The formatting may be performed by the formatter/packager 140 described above, and may include formatting for size, splitting, concatenating, or changing a format, e.g., video to audio, as described above. Then, in operation S240, the educational content module 130 may be sent according to the user delivery preferences. It may take into account the type of user device being sent to, bandwidth limitations, and the like.

In operation S250, the feedback processor 180 may receive feedback about the education content module 130 from the user 10. This feedback may be utilized, in operation S260, to adjust the educational interest preferences or other preferences of the user, as well as adjust the frequency or contents in which the module 130 is presented to others. The system 100 may then repeat the process at operation S225, using the modified user preferences.

### General Computer and Network Architecture

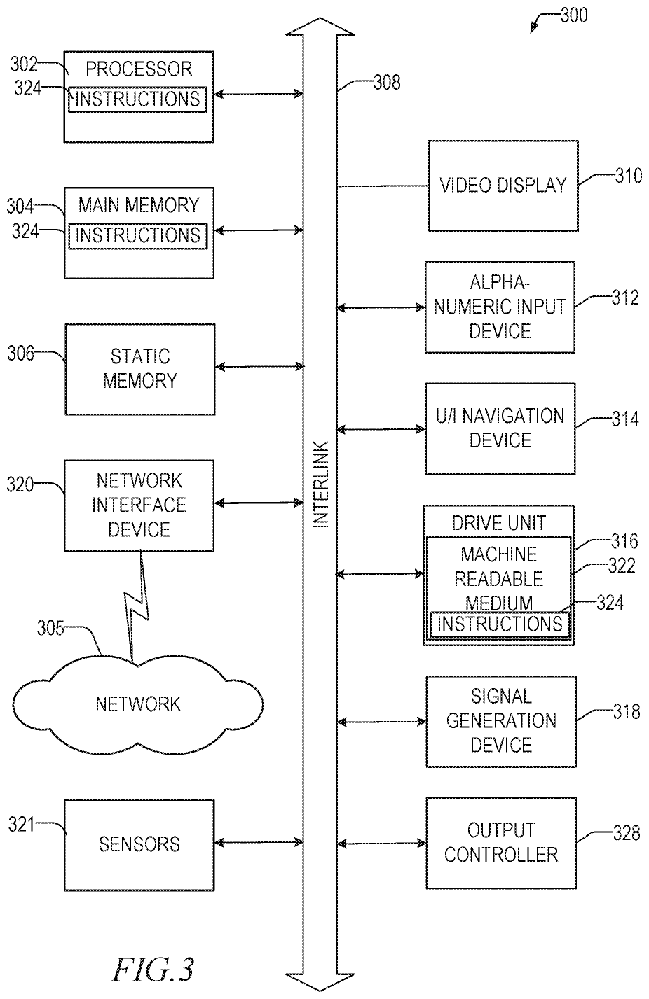

To describe some configurations in greater detail, reference is made to examples of hardware structures and interconnections usable in the designs of the present disclosure. FIG. 3 is a block diagram illustrating a machine 300 that may be a computer or computer system on which various processes described herein may be performed. The machine 300 or multiple such machines may form various parts or all of the system 100 described above. Such a machine 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The machine 300 may further include a display unit 310, an alphanumeric input device 312 (e.g., a keyboard), and a user interface (UI) navigation device 314 (e.g., a mouse). In an example described herein, the display unit 310, input device 312 and UI navigation device 314 may be a touch screen display. The machine 300 may additionally include a storage device (e.g., drive unit) 316, a signal generation device 318 (e.g., a speaker), a network interface device 320, and one or more sensors 321, such as a global positioning system (GPS) sensor, compass, accelerometer, or other sensor. The machine 300 may include an output controller 328, such as a serial (e.g., universal serial bus (USB)), parallel, or other wired or wireless (e.g., infrared(IR), near field communication (NFC), etc.) controller connection to communicate or control one or more peripheral devices (e.g., a printer, card reader, etc.).

The storage device 316 may include a machine readable medium 322 on which is stored one or more sets of data structures or instructions 324 (e.g., software) embodying or utilized by any one or more of the techniques or functions described herein. The instructions 324 may also reside, completely or at least partially, within the main memory 304, within static memory 306, or within the hardware processor 302 during execution thereof by the machine 300. In an example, one or any combination of the hardware processor 302, the main memory 304, the static memory 306, or the storage device 316 may constitute machine readable media.

While the machine readable medium 322 is illustrated as a single medium, the term “machine readable medium” may include a single medium or multiple media (e.g., a centralized or distributed database, and/or associated caches and servers) configured to store the one or more instructions 324.

The term “machine readable medium” may include any medium that is capable of storing, encoding, or carrying instructions for execution by the machine 300 and that cause the machine 300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 324 may further be transmitted or received over the communications network 305 using a transmission medium via the network interface device 320. The term “transmission medium” is defined herein to include any medium that is capable of storing, encoding, or carrying instructions for execution by the machine, and includes digital or analog communications signals or other medium to facilitate communication of such software.

The machine 300 may communicate with one or more other machines 300 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 302.11 family of standards known as Wi-Fi®, IEEE 302.16 family of standards known as WiMax®), IEEE 302.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 300. In an example, the network interface device 320 may include one or more physical jacks (e.g., Ethernet, coaxial, or phone jacks) or one or more antennas to connect to the communications network 305.

In an example, the network interface device 320 may include a plurality of antennas to wirelessly communicate using at least one of single-input multiple-output (SIMO), multiple-input multiple-output (MIMO), or multiple-input single-output (MISO) techniques. In some examples, the network interface device 320 may wirelessly communicate using Multiple User MIMO techniques.

A wide variety of computing devices may constitute a machine 300, as described herein. The following list includes a variety of devices that may fit the definition of a machine 300: a personal data assistant (PDA), a cellular telephone, including a smartphone, a tablet computing device, a laptop computer, a desktop computer, a workstation, a server computer, a mainframe computer, and the like.

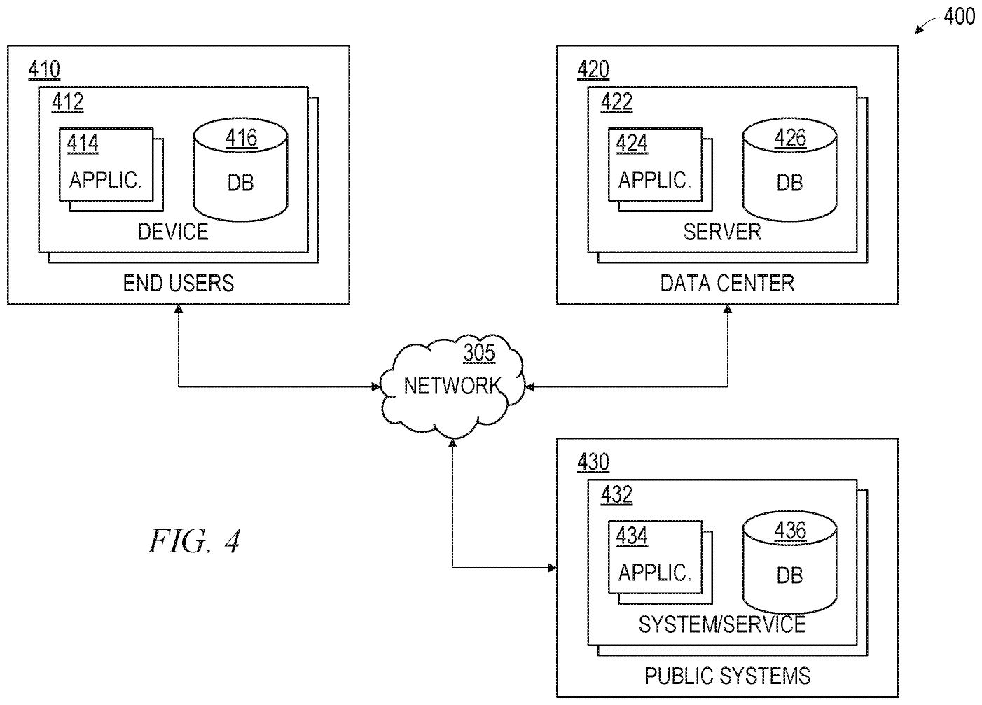

FIG. 4 is a block diagram of a distributed system 400 that may include a user-server architecture or cloud computing system. The system 400 may be a system 100 as described above. Distributed system 400 may have one or more end users 410. An end user 410 may have various computing devices 412, which may be machines 400 as described above. The end-user computing devices 412 may comprise applications 414 that are either designed to execute in a stand-alone manner, or interact with other applications 414 located on the device 412 or accessible via the network 305. These devices 412 may also comprise a data store 416 that holds data locally, the data being potentially accessible by the local applications 414 or by remote applications.

The system 400 may also include one or more data centers 420. A data center 420 may be a server 422 or the like associated with a business entity that an end user 410 may interact with. The business entity may be a computer service provider, as may be the case for a cloud services provider, or it may be a consumer product or service provider, such as a retailer. The data center 420 may comprise one or more applications 424 and databases 426 that are designed to interface with the applications 414 and databases 416 of end-user devices 412. Data centers 420 may represent facilities in different geographic locations where the servers 422 may be located. Each of the servers 422 may be in the form of a machine(s) 300.

The system 400 may also include publicly available systems 430 that comprise various systems or services 432, including applications 434 and their respective databases 436. Such applications 434 may include news and other information feeds, search engines, social media applications, and the like. The systems or services 432 may be provided as comprising a machine(s) 300.

The end-user devices 412, data center servers 422, and public systems or services 432 may be configured to connect with each other via the network 305, and access to the network by machines may be made via a common connection point or different connection points, e.g. a wireless connection point and a wired connection. Any combination of common or different connections points may be present, and any combination of wired and wireless connection points may be present as well. The network 305, end users 410, data centers 420, and public systems 430 may include network hardware such as routers, switches, load balancers and/or other network devices.

Other implementations of the system 400 are also possible. For example, devices other than the user devices 412 and servers 422 shown may be included in the system 400. In an implementation, one or more additional servers may operate as a cloud infrastructure control, from which servers and/or users of the cloud. infrastructure are monitored, controlled and/or configured. For example, some or all of the techniques described herein may operate on these cloud infrastructure control servers. Alternatively, or in addition, some or all of the techniques described herein may operate on the servers 422.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to he illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for preparing and transmitting an education content module to a user associated with a user device having a global positioning sensor (GPS), the method comprising, using a processor:
producing an education content module;
storing the education content module in an educational content module database;
storing a user packaging preference for packaging of the education content module, the user packaging preference being inferred by historical viewing habits of a user;
storing, by an application server, a delivery preference associated with the user, the delivery preference being inferred by the historical viewing habits of the user and specifying a data amount limitation specific to a particular device type of the user;
determining a time of day
responsive to detecting, by the application server, the user is accessing education content via a user device of the particular user device type:
receiving location information from the user device GPS;
formatting, by the application server, contents of the education content module into a specific delivery format according to the user packaging preference, the time of day, a type of the user device, and the location information, the formatting including adjusting a resolution of the education content module based on the time of day. the type of user device, the location information, the historical viewing habits of the user, and the data amount limitation; and
sending, by the application server, the formatted education content module to the user device via a network interface according to the delivery preference based on the historical viewing habits of the user and according to the data amount limitation of the particular user device type.

2. The method of claim 1, wherein the user packaging preference includes information related to a size, level of detail, and level of sophistication.

3. The method of claim 1, wherein the user delivery preference includes information related to a device of the user and delivery format.

4. The method of claim 3, wherein the delivery format comprises at least one of email, text message, chat, web page, web link, or dedicated application display screen.

5. The method of claim 1, further comprising selecting the education content module utilizing tags of the tagged education content module based on an inferred educational interest.

6. The method of claim 5, further comprising determining the inferred educational interest based on at least one of a portfolio of the user, indicated interests, current knowledge, prior education content modules viewed, or demographic information.

7. The method of claim 1, wherein the user delivery preference is inferred based on a location.

8. (canceled)

9. The method of claim 1, further comprising revising the user packaging preference or the user delivery preference based on feedback received from the user.

10. The method of claim 1, further comprising concatenating multiple education content modules or splitting an education content module prior to the formatting.

11. The method of claim 1, wherein the content is formatted as a digital notebook within the formatted education content module, wherein the education content is configured to be presented within an unsecure portion of the digital notebook that does not require authentication credentials to access the education content, and wherein financial information is presented within a secure portion of the digital notebook, the secure portion requiring authentication credentials for access; wherein the sending of the formatted educational module is provided within the unsecure portion.

12. The method of claim 1, wherein the formatting of the contents comprises converting content of the education content module into a different format.

13. A personalized user education system comprising:
a hardware processor;
a network interface;
a non-volatile memory-based storage device connected to the hardware processor comprising instructions that, when executed on the processor, configure the hardware processor to perform operations comprising:
storing an education content module in an educational content module database;
storing a user packaging preference for packaging of the education content module,
the user packaging preference being inferred by historical viewing habits of a user;
storing a delivery preference for the user associated a user device having a global positioning sensor (GPS), the delivery preference being inferred by the historical viewing habits of the user and specifying a data amount limitation specific to the user device;
determining a time of day;
responsive to detecting the user is accessing education content via the user device:
receiving location information from the user device GPS;
formatting contents of the education content module into a specific delivery format according to the user packaging preference, the time of day, a type of the user device, and the location information, the formatting including adjusting a resolution of the education content module based on the time of day the type of user device, the location information, the historical viewing habits of the user, and the data amount limitation; and
sending the formatted education content module to the user via the network interface according to the user delivery preference based on the historical viewing habits of the user and according to the data amount limitation of the user device.

14. The system of claim 13, wherein the user packaging preference includes information related to a size, level of detail, and level of sophistication.

15. The system of claim 13, wherein the user delivery preference includes information related to a device of the user and delivery format.

16. The system of claim 15, wherein the delivery format comprises at least one of email, text message, chat, web page, web link, or dedicated application display screen.

17. The system of claim 13, the operations further comprising selecting the education content module utilizing tags of the tagged education content module based on an inferred educational interest.

18. The system of claim 17, the operations further comprising determining the inferred educational interest based on at least one of a user's portfolio, indicated interests, current knowledge, prior education content modules viewed, or demographic information.

19. The system of claim 13, wherein the user delivery preference is inferred based on at least one of a time of day, a currently in-use user device, a location, and historical records of viewing habits of the user.

20. A non-transitory computer-readable storage medium, the computer-readable storage medium including instructions that when executed by a processor, cause the processor to:
receive educational information from a network interface;
process and store in a memory the educational information to produce an education content module that is tagged based on its content with a content engine;
determine and store in the memory a user packaging preference for packaging of the education content module, the user packaging preference being inferred by historical viewing habits of a user;
store a user delivery preference for the user associated with a user device having a global positioning sensor (GPS), the delivery preference specifying a data amount limitation specific to the user device;
determine a time of day;
responsive to detecting the user is accessing education content via the user device:
receive location information from the user device GPS;
format contents of the education content module into a specific delivery format according to the user packaging preference, the time of day, a type of the user device, and the location information, the formatting including adjusting a resolution of the education content module based on the time of day, the type of user device, the location information, the historical viewing habits of the user, and the data amount limitation; and
send the formatted education content module to the user via the network interface according to the user delivery preference based on the historical viewing habits of the user and according to the data amount limitation of the user device.

21. The method of claim 1, further comprising modifying the data amount limitation based on a time of day.

22. The method of claim 1, further comprising:
providing, to a training engine, an indication from an advisor of a user's interest in new material;
receiving, from the advisor, an instruction to push the new material to the user; and
providing the new material to the user in response to the instruction.
